(19) United States
(12) Patent Application Publication
(10) Pub. No.: US 2024/0389613 A1
(43) Pub. Date: Nov. 28, 2024

(54) SWING ARM DISPENSER ASSEMBLY FOR USE WITH AN EDIFICE

(71) Applicant: Snowie LLC, Salt Lake City, UT (US)

(72) Inventor: Carl A. Rupp, Salt Lake City, UT (US)

(73) Assignee: Snowie LLC, Salt Lake City, UT (US)

(21) Appl. No.: 18/412,433

(22) Filed: Jan. 12, 2024

Related U.S. Application Data
(60) Provisional application No. 63/588,641, filed on Oct. 6, 2023.
(60) Provisional application No. 63/479,727, filed on Jan. 12, 2023.

(51) Int. Cl. A23G 9/28; A23G 9/24; B60P 1/00

(52) U.S. Cl. CPC A23G 9/28; A23G 9/245; B60P 1/00

(57) ABSTRACT

A system comprising an arm configured to be mounted to an edifice, wherein the arm is configured to move between an open position and a closed position, a dispenser assembly mounted to the arm, and one or more tubes configured to span a length of the arm and terminate at the dispenser assembly, wherein the one or more tubes are configured to transport fluid along the length of the arm to the dispenser assembly.

### TECHNICAL FIELD

The present disclosure relates generally to frozen confections, and more specifically to a system for dispensing and serving frozen confections from a edifice.

### BACKGROUND

The disclosure relates generally to edifices and vehicles for use in preparing, dispensing, and topping shaved ice or snow cone confectioneries, and more particularly, but not necessarily entirely, to a mobile edifice for use in providing shaved ice or snow cones prepared by a machine for that purpose and a topping dispenser for topping and flavoring shaved ice or snow cone confectionaries.

A variety of machines have been developed, described and are widely known for creating or processing cold deserts and confectioneries by processing ice into more appealing eatable forms, such as snow cones and shaved ice. Such devices produce either ice granules (snow cones) or light, fluffy, finely textured shaved ice for subsequent flavoring using syrups. Dispensing the syrups as toppings to a usually unflavored ice product can be time consuming for workers. Additionally, most customers desire different levels or amounts of toppings or flavoring syrups. Thus, it is advantageous to make topping dispensers available for customer use such that a customer can flavor the base ice product themselves.

In some instances, a user may desire to sell frozen confections at events such as sporting events. During these events there may be limited periods, such as a halftime, where potential customers may desire a snack. Traditional frozen confection vendors will sell and prepare frozen confections from the same stall or kiosk or window of a truck, which may result in long lines as customers wait for an attendant to both process their purchase and prepare their snack. By deploying flavoring dispensers away from the position of the sale, a user may process a customer's purchase of a frozen confection and allow the customer to prepare their own flavoring in another location, thus allowing for shorter lines and quicker service. Disclosed herein are systems and methods for deploying topping and other flavor dispensing mechanisms away from a point of sale to facilitate customer self-service.

As disclosed herein below, the disclosure provides an apparatus, system and method for providing a topping dispenser or a plurality of topping dispensers on a mobile edifice, vehicle or other structure for customer use.

The features and advantages of the disclosure will be set forth in the description, which follows, and in part will be apparent from the description, or may be learned by the practice of the disclosure without undue experimentation. The features and advantages of the disclosure may be realized and obtained by means of the instruments and combinations particularly pointed out in the appended claims. Any discussion of documents, acts, materials, devices, articles or the like, which has been included in the specification is not to be taken as an admission that any or all of these matters form part of the prior art base, or were common general knowledge in the field relevant to the disclosure as it existed before the priority date of each claim of this disclosure.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 shows a schematic diagram of an overview of a deployed dispenser assembly attached to an edifice via a swing arm.

FIG. 2A shows a schematic diagram of an overhead view of a dispenser assembly.

FIG. 2B shows a schematic diagram of a front view of a dispenser assembly.

FIG. 3. shows a schematic diagram of an overhead perspective view of an expanded dispenser assembly.

FIG. 4 shows a schematic diagram of an exploded front view of a dispenser assembly.

FIG. 5A shows a schematic diagram of an overhead view of an isolated upper portion of a dispenser assembly.

FIG. 5B shows a schematic diagram of an overhead view of an underside of an isolated upper portion of a dispenser assembly.

FIG. 6 shows a schematic diagram of an overhead perspective view of an isolated lower portion of a dispenser assembly.

FIG. 7 shows a schematic diagram of a side view of a swing arm dispenser assembly mounted to an edifice having a stored dispenser assembly attached via a swing arm.

FIG. 8 shows a schematic diagram of a side view of a swing arm dispenser assembly mounted to an edifice with a closed hatch door.

FIG. 9 shows a schematic diagram of a perspective side view of a swing arm dispenser assembly mounted to a mobile edifice having two deployed dispenser assemblies each attached via a swing arm.

FIG. 10A shows a schematic diagram of a side view of a swing arm dispenser assembly mounted to a mobile edifice having two swing arm dispenser assemblies that deploy vertically.

FIG. 10B shows a schematic diagram of a side view of a swing arm dispenser assembly mounted to an edifice having a horizontal swing arm and a vertical swing arm.

FIG. 11 shows a schematic diagram of a side view of a swing arm dispenser assembly mounted to an edifice having secondary topping dispensers.

FIG. 12 shows a schematic diagram of a side view of a swing arm dispenser assembly mounted to an edifice having a cooling chute.

### DETAILED DESCRIPTION

The disclosure extends to methods, systems, and devices for producing a shaved ice or snow cone product. The disclosure relates generally to edifices, including, but not limited to, vehicles, for use in preparing, dispensing and topping shaved ice or snow cone confectioneries, and additionally to a mobile edifice for use in providing shaved ice or snow cones prepared by a machine for that purpose and a topping dispenser for topping and flavoring shaved ice or snow cone confectionaries.

In the following description of the disclosure, reference is made to the accompanying drawings, which form a part hereof, and in which is shown by way of illustration specific implementations in which the disclosure may be practiced. It is understood that other implementations may be utilized and structural changes may be made without departing from the scope of the disclosure.

Before the methods, systems and devices for producing a shaved ice or snow cone product are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

As used herein, the terms “shaved ice” and/or “snow cone” refer broadly to the large family of ice-based desserts or confections made from the fine shavings of ice or finely crushed ice. It will be appreciated that shaved ice and/or snow cones may often include a flavoring that may be a syrup or other sweetened condiment that is added to the shaved ice or snow cone. Similarly, the terms “ice shaving” or “snow cone” in reference to a machine are intended broadly to include all machines used to make or produce the large family of ice-based desserts or confections that may be classified as shaved ice or snow cone products.

As used herein, the term “edifice” is used to refer broadly to structures that generally form a boundary from which other structures can be attached and from which to provide frozen confections. An edifice may be its own stand-alone structure or may be part of another structure.

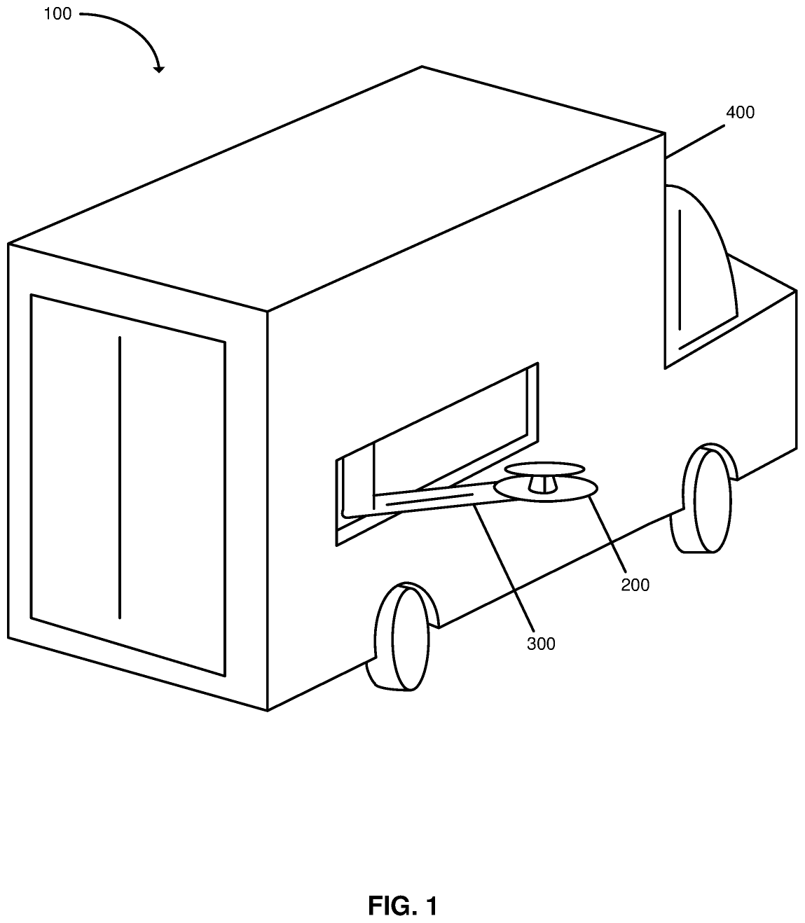

FIG. 1 shows a schematic diagram of a perspective view of a system 100 comprising edifice 400 having a dispenser assembly 200 according to the principles of the present disclosure. The dispenser assembly 200 may be mounted or otherwise attached to edifice 400 via an arm 300. The arm 300 may be joined to the edifice 400 and may freely pivot about an axis in some implementations, while in others the arm may be fixed. The arm 300 may be mounted to a sidewall of an edifice 400, to a roof, to a front or rear, or anywhere suitable at some point on an edifice 400. The sidewall 400 may comprise a wall of the edifice, a shelf, a stand, a door, or a similar construct suitable for mounting an arm thereto, depending on the implementation. The dispenser assembly 200 may be mounted to a distal end of the arm 300 in some implementations, while in others one or more dispenser assemblies may be positioned at various positions along the length of the arm 300. In some implementations more than one arm 300 may be mounted to an edifice. In such cases these arms 300 may be mounted at roughly the same point together or each may be independently mounted to separate positions on an edifice 400.

It should be noted that while FIG. 1 shows edifice 400 as a truck, the present disclosure is not limited to trucks. An edifice 400 may be a different sort of structure depending on the implementation. In some implementations, an edifice 400 may be a wheeled cart or kiosk. In other implementations, an edifice 400 may be a stand. In yet other implementations, the edifice 400 may be any sort of structure that may be deployed in an area where one may sell frozen confections or similar treats upon which a swing arm 300 could be mounted are within the scope of this disclosure.

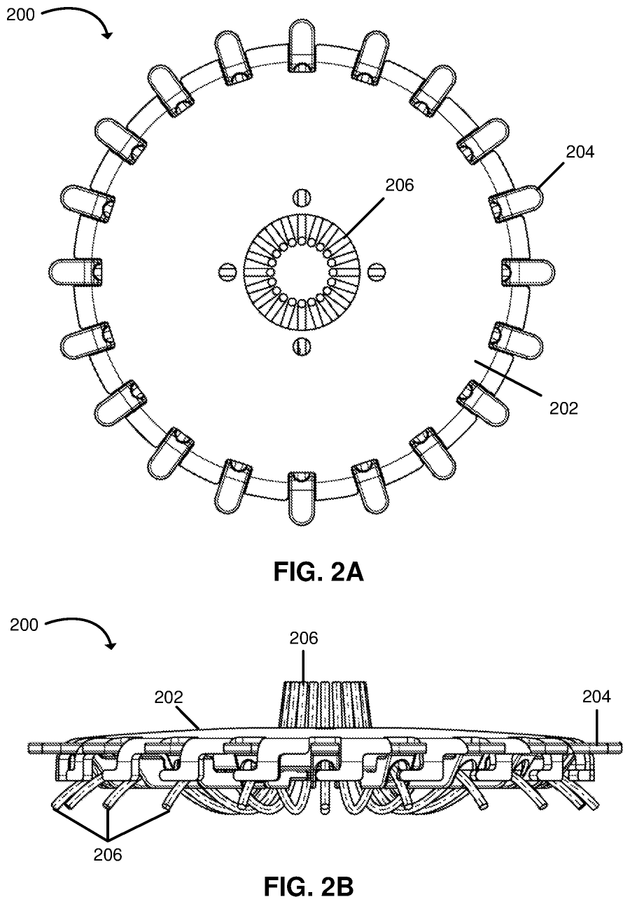

FIG. 2A shows a schematic diagram of an overhead view of a dispenser assembly 200.

A dispenser assembly 200 may include an upper portion 202 and a lower portion 204. The dispenser assembly 200 may have a tubing 206 comprising a plurality of individual tubes disposed within the dispenser assembly 200. In some implementations the upper portion 202 may be of an overall round, disk shape and be configured to be positioned on top of the lower portion 204. In other implementations the orientation of the upper portion 202 and the lower portion 204 may be reversed, such that the lower portion 204 as shown here acts as an upper portion, and the upper portion 202 acts as a lower portion. In some implementations the dispenser assembly may be reversible, such that the specific orientation of the upper portion 202 and lower portion 204 may be interchangeable. While the upper portion 202 and lower portion 204 are shown here in an overall disc-shape, it should be appreciated that other shapes may be utilized depending on the implementation. In some implementations the upper portion 202 and lower portion 204 may each comprise an overall square shape, triangle shape, or other shape to suit the needs of a user. Depending on the implementation, a dispenser assembly 200 may resemble a saucer assembly as disclosed in U.S. Pat. No. 10,130,111 (“Flavor Station Assembly”) or U.S. Pat. No. 10,834,939 (“Flavor Station Assembly”), the disclosures of both of which are incorporated herein by reference.

Shown in FIG. 2B, the upper portion 202 and the lower portion 204 may join and interlock such that the ends of the individual tubes of the tubing 206 exit from openings formed by the joined upper portion 202 and lower portion 204. These openings may form a number of dispensing terminals. Tubing 206 may also be routed through the upper portion and the lower portion and may pass through a central opening in each of the upper portion 202 and the lower portion 204.

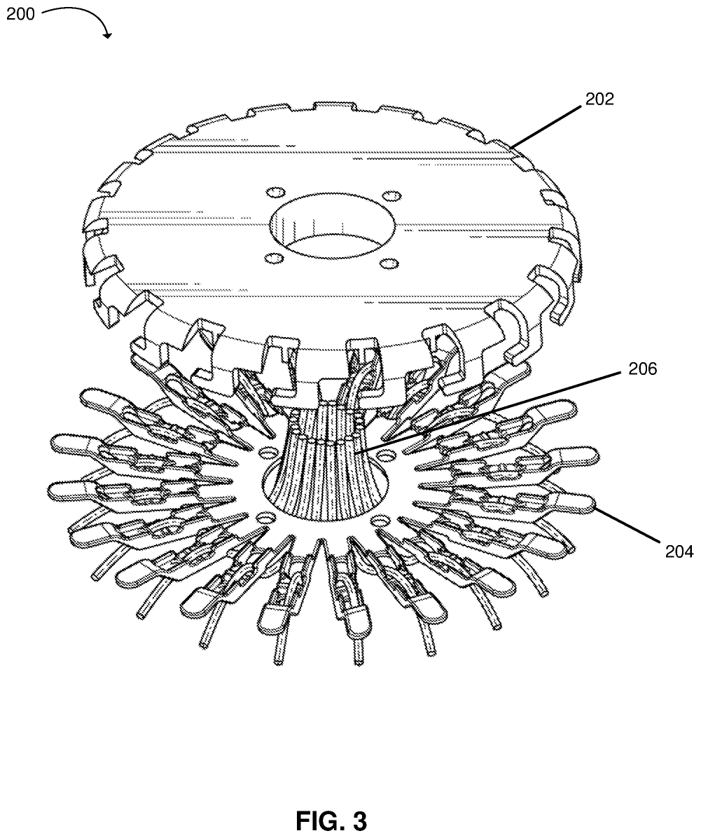

FIG. 3 shows a schematic diagram of a perspective expanded view of a dispenser assembly 200. In some implementations, in the course of use, the upper portion 202 may be positioned above the lower portion 204. In some implementations the upper portion 202 and the lower portion 204 may be similarly sized to facilitate the joining of the upper portion 202 and lower portion 204. In other implementations one portion may be larger than the other according to the system's needs.

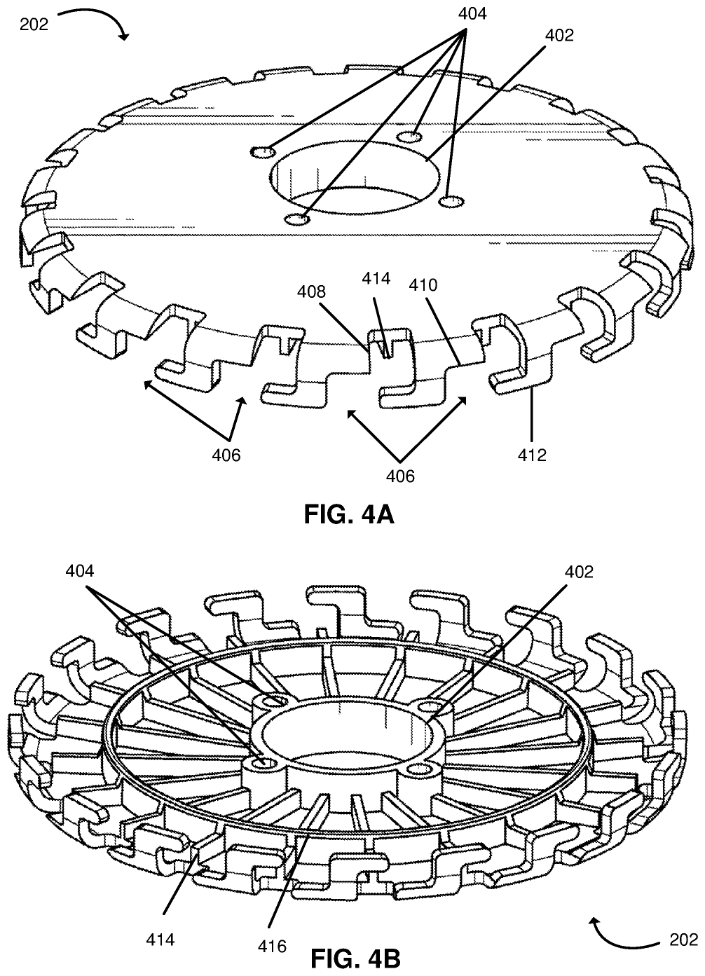

FIG. 4A shows a schematic diagram of an overhead perspective view of an upper portion 202 of a dispenser assembly 200 in isolation. The upper portion may include a central opening 402 and a number of mounting holes 404 positioned around the central opening 402. The upper portion 202 may comprise a plurality of vertical arms (not shown) that can each include a coupling component (not shown) that includes holes corresponding to mounting holes 404 in order to facilitate mounting. As an example, the coupling component may have an outside diameter greater than the outside diameter of the arm (as seen in FIG. 1), and that includes one or more threaded holes that align with mounting holes 404 when central opening 402 is aligned with the arm. A fastening component, such as a bolt, screw, or similar may be used to secure the dispenser assembly to the coupling component of the arm.

The upper portion 202 may comprise a disk-shaped component and may further comprise a relatively flat top surface and a sidewall that extends downwardly from the outer edge of the top surface. The sidewall may comprise a plurality of stepped channels 406 formed therein and spaced around the sidewall. Each channel 406 may include a main channel 408 and an ingress channel 410. In some implementations the main channel 408 may overlap the ingress channel 410 and may further be situated at an offset from the ingress channel 410. In other implementations the main channel 408 may not overlap the ingress channel 410. The main channel 408 may form a deeper recess than the ingress channel 410. The difference in height between the two channels together with an offset may form a step between the main channel 408 and ingress channel 410. A retaining ledge 412 may extend outwardly into the main channel 408 and be positioned below the main channel 408. A top surface of the retaining ledge 412 may be offset relative to the top surface of the ingress channel 410 to allow passage between the main channel 408 and the ingress channel 410.

FIG. 4B shows a schematic diagram of an overhead perspective view of an underside of an upper portion 202. A plurality of radial ribs 414 may be formed on the underside of the top surface of the upper portion 202. The radial ribs 414 may reinforce the top surface and provide structural support. In some implementations the radial ribs 414 may align with main channels 408. A ridge 416 may also be formed on the underside of the top surface of the upper portion 202. The ridge 416 may take on an overall circular shape. The ridge 416 may form a clamping surface that may occlude tubing 206 and may extend downwardly beyond the radial ribs 414.

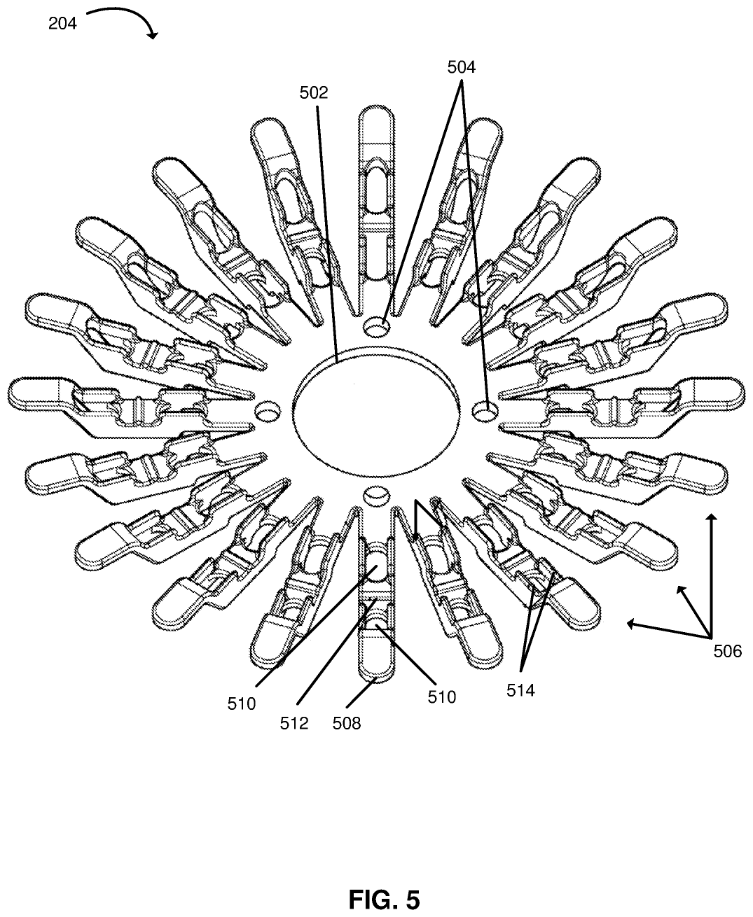

FIG. 5 shows a schematic diagram of an overhead perspective view of a lower portion 204 of a dispenser assembly in isolation. A lower portion 204 can include a central opening 502 and a number of mounting openings 504. The lower portion 204 may include a number of buttons 506 that extend radially from a central portion of the lower portion 204. The number of buttons 506 can correspond with the number of channels (406, seen in FIG. 4A). The width of buttons 506 can also correspond with the width of channels thereby allowing buttons 506 to be retained within channels.

Each button 506 can include a press tab 508 formed at its end and two openings 510 spaced along its length. Also, sidewalls 514 can be formed on opposite sides of each button 506 along openings 510 to provide reinforcement to button 506. The end of button 506 can be angled upwardly so that push tab 508 is positioned above openings 510. Also, as shown in the depicted embodiment, opening 510 can be formed partially within this upwardly angled portion of button 506. Each button 506 may also include a button ridge 512 that substantially aligns with circular ridge 512 when dispenser assembly 200 is assembled. Button ridges 512 can function as clamping surfaces to occlude tubing 206.

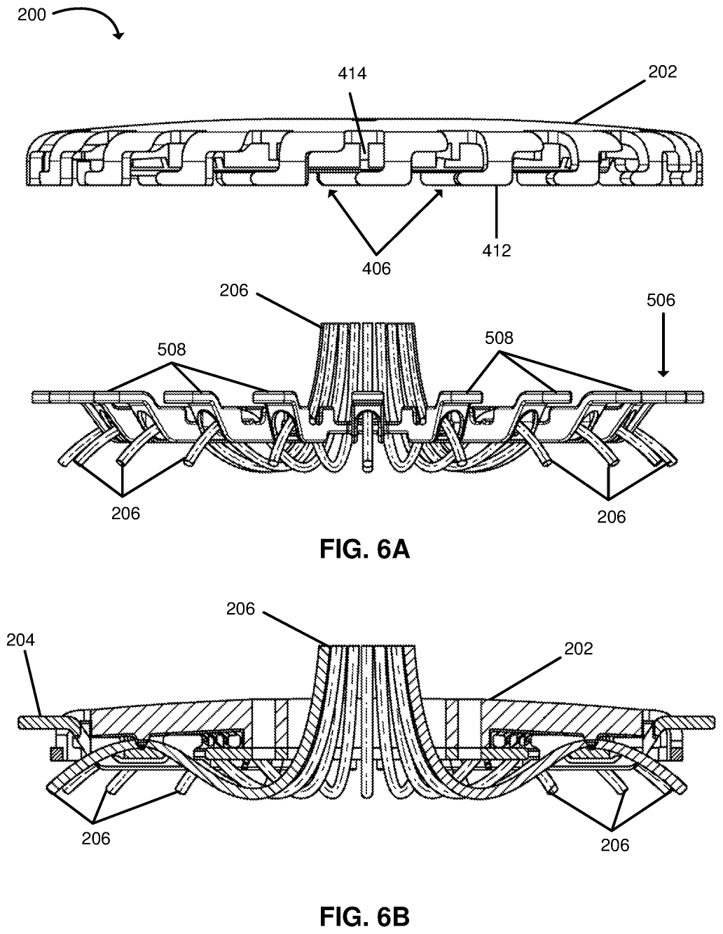

FIG. 6A shows a schematic diagram of an exploded side view of a dispenser assembly 200. The upper portion 202 may form a substantially flat shape, whereby an upper surface of the upper portion 202 may be overall slightly curved. The lower portion 204 may have a substantially flat shape whereby each end, forming an outer edge, may be biased upwards. In some implementations the outer edge may remain substantially flat and in others the outer edge may bias in a downwards direction from the bottom surface. The tubing 206 may comprise a grouping one or more individual tubes, where each individual tube feeds to one of a plurality of openings that each support an end of one tube of the tubing 206.

FIG. 6B shows a schematic diagram of a cross-sectional side view of dispenser assembly 200 when assembled. To assemble lower portion 204 with upper portion 202, buttons 506 can be aligned with and then inserted into ingress channels 510. With buttons 506 inserted into ingress channels 510, lower portion 204 can be twisted or otherwise manipulated relative to the upper portion 202 (e.g., to the right in the depicted embodiment) thereby positioning buttons 506 within main channels 508. The lower portion 204 can then be tightened against the upper portion 202 (e.g., by tightening fastening components, like bolts for example, through mounting holes 504). With lower portion 204 secured to the upper portion 202, press tabs 508 will be positioned towards the top of main channels 508 and ridges 512 will be forced against circular ridge 518. Buttons 506 can be formed of a resilient material (e.g., plastic) so that they will be biased into this clamped position.

The tubing 206 pass through central opening 502 of the upper portion and central opening 502 of the lower portion. Each individual tube can then be routed upwardly through opening 502 and then downwardly through opening 502 to position the end of the tube generally below press tab 506. Due to the biasing of buttons 506, tubing 206 will remain clamped between ridges 516 and circular ridge 518 thereby preventing the flow of flavoring syrup. Then, when it is desired to dispense a particular flavoring syrup, a consumer can press down on the appropriate press tab 606 to thereby unclamp the corresponding tube. Retaining ledge 512 will limit the movement of press tab 508 to thereby prevent button 506 from becoming broken. Tubing 206 can be primed such that the flavoring syrup will flow once the tubing is unclamped. Due to the resiliency of button 506, the tubing will again be clamped once the consumer releases press tab 508.

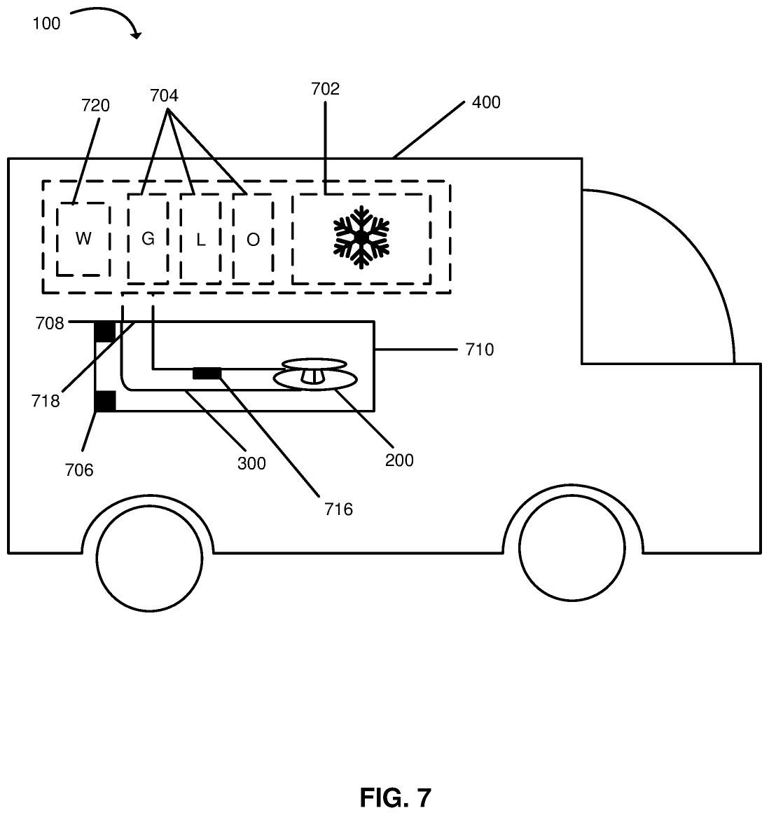

While FIGS. 1-6B show a dispenser assembly showing an upper portion 202 and lower portion 204 together, it will be appreciated by those of ordinary skill that it is not necessary to have both the upper portion 202 and lower portion 204 together. In some implementations a user may elect to utilize only an upper portion 202 as in FIG. 4A. In such an implantation an upper portion 202 may be mounted individually to an arm like the one shown in FIG. 7. In instances where a user only mounts a single portion, a user may feed tubing through central opening 402 and secure the terminal ends of the tubing in within channels 406 and retaining ledges 612. A user may utilize an alternate means to stop and dispense liquid through the tubing, such as individual nozzles, spouts, faucets or other similar mechanisms. A user may affix these nozzles or other similar mechanisms to a terminal end of each of however many tubes a user chooses to use. Similarly, in other implementations a user may choose to only use a lower portion 204, which may retain the press tabs 508 and buttons 506 to control dispensation of liquid. A user may additionally elect to utilize nozzles, spouts, faucets, or similar mechanisms attached to terminal ends of tubing even when using both the upper portion 202 and lower portion 204 of dispenser assembly 200 are used together to provide greater control over the dispensing of whatever fluid the tubes are configured to dispense.

FIG. 7 shows a schematic diagram of a side view of a system having edifice 400 having a dispenser assembly 200 mounted to an arm 300 and disposed within an edifice recess 710. Within the edifice there may be a coolant provider 702 and one or more of primary reservoirs 704. The coolant provider 702 may comprise a tank containing a type of liquid or gaseous coolant. The coolant may be routed via separate tubing to the primary reservoirs 704, through the arm 300 to the dispenser assembly 200, or to both simultaneously. The coolant tubing (not shown) may interact with tubing from the primary reservoirs 704 to cool and maintain the temperature of the flavoring. The primary reservoirs 704 may comprise tanks, bags, or other suitable container structure containing one or more flavors, which may be a liquid or may in some instances be a solid, to be dispensed from the dispenser assembly 200. The tubing, not presently shown but as seen in FIGS. 2-4, may originate from these primary reservoirs 704 and run along a length of, and sometimes through an interior of, an arm 300 before terminating at the dispenser assembly 200. The primary reservoirs 704 shown in FIG. 7 may contain a variety of different flavored syrups. In the figure, the primary reservoirs 704 are shown with exemplary labels “G” for grape, “L” for lemon, and “O” for orange. These labels are for purpose of example and are not intended to be limiting. In other implementations any number of flavor syrups, individually or in combination, may be contained within the primary reservoirs 704 and dispensed from the dispenser assembly 200. In some implementations instead of or in addition to flavor syrups, primary reservoirs 704 may contain water, juice, sodas, or other similar types of fluids.

The edifice 400 may be a truck or van or another vehicle. While a truck is shown in the figure as an example it is not necessary for the edifice 400 to be a motorized vehicle. The present disclosure may also extend to carts, wagons, hand trucks, or other such vehicles to which a dispenser assembly 200 and arm 300 may be mounted. The present disclosure may additionally extend to kiosks, stands, or other standing structures that could be transported by truck from one location to another. The arm may be disposed within an edifice recess 710. The recess 710 may comprise an opening extending into the interior of the edifice 400 or may have one or more back and sidewalls defining the recess as a cavity within a sidewall of the edifice 400. Within the recess 710 may be a number of mechanisms, such as a locking mechanism 706, a deployment mechanism 708, or both. The locking mechanism 706 may comprise a button, lever, or comparable means to facilitate locking the arm 300 to a particular position. An arm 300 may be fully disposed within the recess 710 in a stored position, as seen here in FIG. 7. The arm 300 may also extend from the recess 710 away from the edifice 400 in a deployed position (as seen in FIG. 1). It will be appreciated that while reference is made to “horizontal” swing arms and “vertical” swing arms in this disclosure, a swing arm 300 may not move in a perfectly horizontal or vertical way relative to the edifice 400. In some implementations, a swing arm 300 may deploy at an angle relative to a sidewall of an edifice 400. The locking mechanism 706 may be utilized to lock the position of the arm 300 in the stored position, the deployed position, or somewhere in between in a partially deployed position.

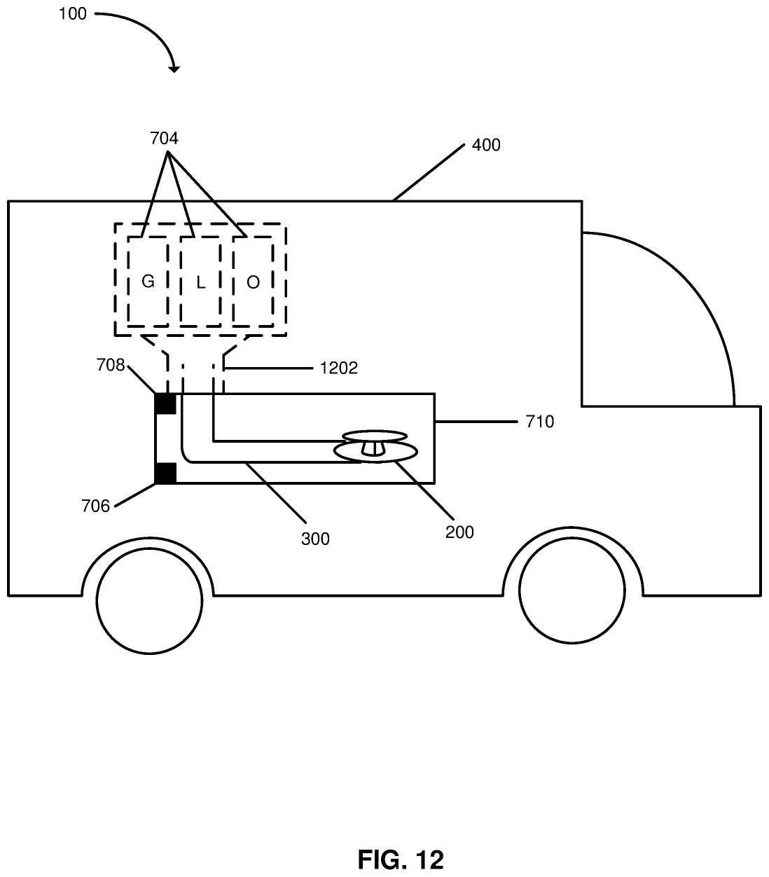

The arm 300 may additionally feature a secondary dispenser 716. The secondary dispenser 716 may comprise a faucet, spigot, nozzle, a hole, or other mechanism configured to dispense a fluid from a source within the edifice 400. The source may be one of the primary reservoirs 704 or a secondary reservoir 720 independent from primary reservoirs 704. In some implementations secondary dispenser 716 may be in fluid communication with secondary reservoir 720 via tubing, labeled in FIG. 7 with a “W” to indicate water, as a non-limiting example, though any other fluid is intended to be within the scope of the present disclosure. In other implementations the secondary dispenser may dispense fluid from within the arm 300, like, for example, water, from melted ice deposited into a chute within the edifice 400 (see FIG. 12). The secondary dispenser 716 may comprise a knob, handle, or other similar means that, when manipulated, permits the secondary dispenser 716 to dispense a fluid, depending on the source. In implementations where the secondary dispenser 716 is a hole, the fluid may continuously run or drip from secondary dispenser 716.

While FIG. 7 shows a single secondary dispenser 716 located centrally on arm 300, it will be appreciated that this disclosure is not limited to any number or positioning of secondary dispensers 716. Depending on the implementation, an arm 300 may feature multiple secondary dispensers 716 located at various positions along a length of an arm 300. In features utilizing multiple arms 300, a user may have one or more secondary dispensers 716 on one or several of the multiple arms 300 located at various positions along any of the arms 300. In other implementations a user may forego an secondary dispenser 716 altogether.

It will be appreciated that while FIG. 7 shows primary reservoirs 704 as a grouping and secondary reservoir 720 as an individual container, the present disclosure is not limited to any particular number or configuration of reservoirs. Depending on the implementation a system according to the present disclosure may feature, for example, a sole primary reservoir for one purpose, a group of secondary dispensers for a secondary dispensers for another purpose, and one or more of a tertiary or onward dispenser for yet another purpose, according to the implementation and needs of a user.

The secondary dispenser 716 may allow a user to wash their hands or otherwise receive water in some implementations, while in other implementations a user may receive a different liquid they may use for another purpose. A swing arm 300 according to the present disclosure may optionally feature such a faucet or spigot 716, and may have more than one faucet or spigot 716 depending on the implementation. FIG. 7 shows a secondary dispenser 716 mounted to a central position of swing arm 300, but it will be appreciated that a secondary dispenser 716 may instead be located anywhere on swing arm 300. In some implementations the secondary dispenser 716 may be located on or close to dispenser assembly 200. In other implementations, secondary dispenser 716 may instead be located in another position on edifice 400, and may reside within its own edifice recess.

The arm 300 may be mounted to the edifice 400 by a mount 718. The mount 718 may comprise a ball joint, a linkage, a hinge, or other similar mechanism that permits a user to mount the arm 300 to the edifice 400 while retaining some degree of movement depending on the mount 718 utilized. The mount 718 may retain the arm 300 in a way such that the arm 300 may move between a closed position or open position. In some implementations the mount 718 may be mounted to a sidewall of the edifice, while in other implementations may be mounted to another structure, such as a rack or shelf which may itself be mounted to the edifice. A rack or shelf may or may not be utilized in a situation where a user may desire to use mount 718 to mount an arm 300 to a roof or underside of an edifice 400. In other implementations a user may mount arm 300 via mount 718 to a roof or underside of an edifice 400 directly.

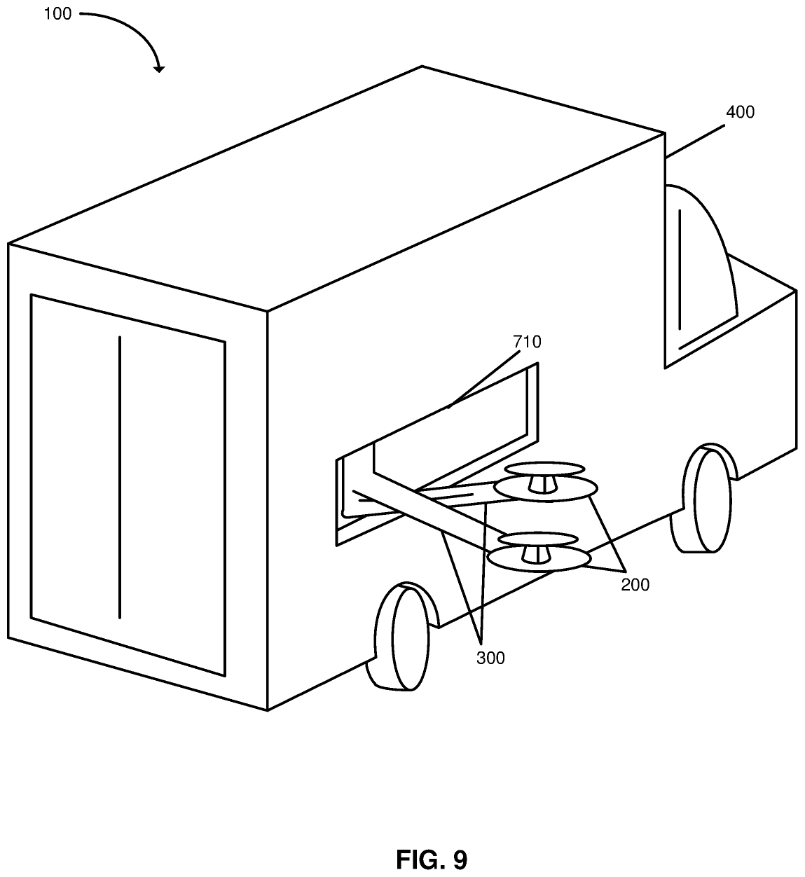

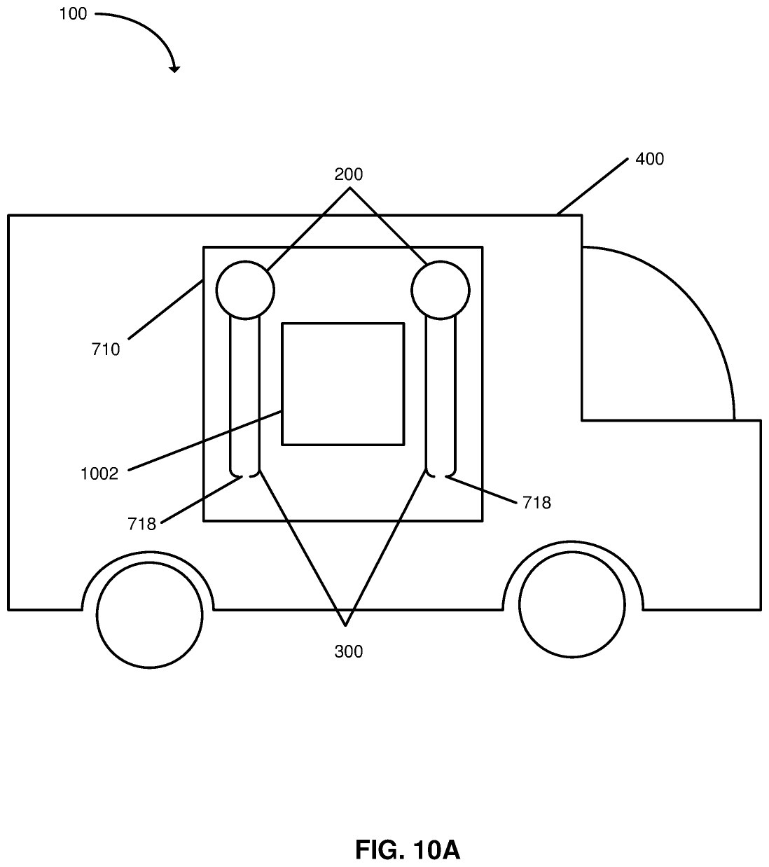

A closed position may be a positioning of arm 300 whereby the arm 300 is maneuvered closer to a sidewall of the edifice 400 for, for example, storage purposes when the arm 300 is not in use and/or while the edifice 400 is travelling or otherwise in motion. In some implementations the closed position may entail an arm 300 positioned within a recess 710 as shown in FIG. 7. An open position may entail a positioning of arm 300 as shown later in FIG. 9. In such a position, an arm may maneuver away from a sidewall of edifice 400. A user may maneuver an arm 300 freely along an axis of movement depending on the type of mount 718 used.

For example, in an implementation where an arm 300 is pivotably mounted an arm 300 may rotate or pivot according to an axis provided by the mount 718. In other implementations a mount 718 may comprise a ball joint in which case an arm 300 may be maneuvered according to the freedom of movement allotted by a ball joint. An open position may comprise an arm 300 being maneuvered fully away from edifice 400 in some implementations, or in others an open position may comprise an arm being maneuvered far enough away from a sidewall of edifice 400 such that a user may sufficiently access a dispenser assembly 200 mounted to an arm 300. Those skilled in the art will appreciate that the precise boundaries of closed position and open position may vary according to the implementation, and that any positioning of arm 300 within its freedom of movement could comprise the open position while arm 300 is in use.

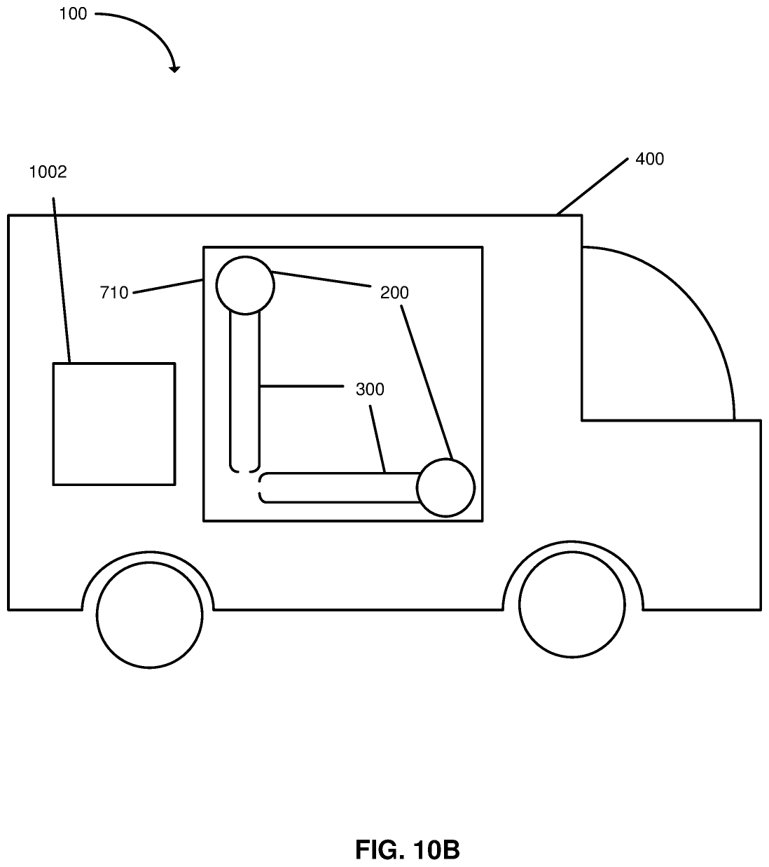

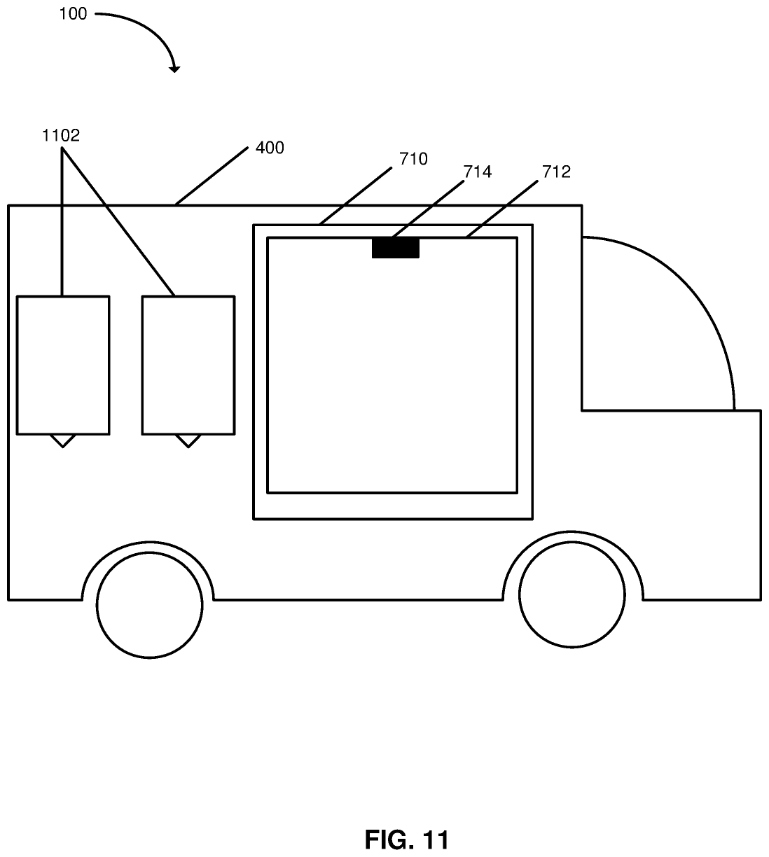

Depending on the implementation, one or more arms 300 may be mounted to an edifice 400 using one or more mounts 718. In some implementations multiple arms 300 may be mounted to edifice 400 by a single mount 718 or mount point as shown in FIG. 7. In other implementations multiple arms 300 may be mounted individually by their own mounts 718, as shown in FIG. 10A. Those skilled in the art will appreciate any number and combination of arms 300 and mounts 718 that may be affixed to an edifice 400 are within the scope of this disclosure.

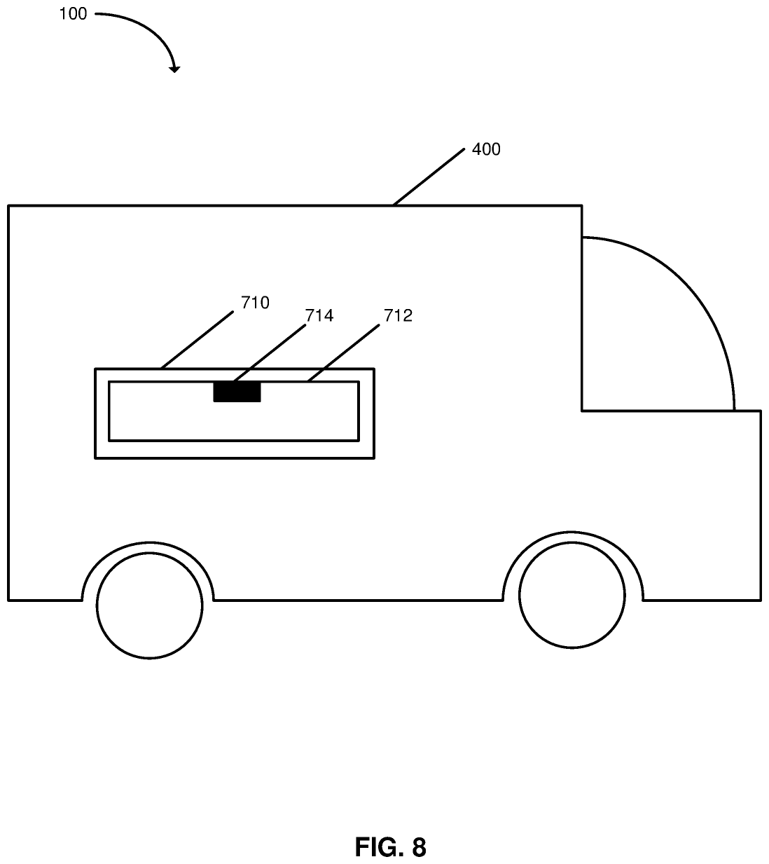

The deployment mechanism 708 may be used to deploy the arm 300 in some implementations, while in others the deployment mechanism 708 may be positioned outside of the recess 710 and used to open or close the hatch door seen in FIG. 8. The deployment mechanism may comprise a button or lever than when manipulated may open or close the hatch door, change the position of the arm 300, or both. In some implementations a single deployment mechanism may, for example, open the hatch door and deploy the arm 300 when manipulated, then store the arm 300 and close the hatch door when manipulated again. In other implementations separate deployment mechanisms may exist, whereby one controls the hatch door and the other controls the arm 300 position. The deployment mechanism 708 may employ a spring or a motor to operate the hatch door or the arm 300. The deployment mechanism 708 may be in electrical communication with a motor in some implementations to facilitate motorized deployment between an open or closed position of a swing arm 300. In other implementations the deployment mechanism 708 may be mechanical in nature and require a user to manually adjust a swing arm 300 between an open and closed position. In yet other implementations the deployment mechanism 708 may comprise a lock, latch or similar mechanism separate from locking mechanism 706 that also secures a swing arm 300 within the edifice recess 710. In some implementations deployment mechanism 708 may comprise both a lock, latch, or similar mechanism as well as a spring, motor, or other means for deploying one or more swing arms 300. In some implementations deployment mechanism 708 may operate a hydraulic system which may deploy or return swing arm 300 out to an open position or back to a closed position within an edifice recess 710.

FIG. 8 shows a schematic diagram of a side view of a system 100 featuring an edifice 400 having an edifice recess 710 and a panel 712. The panel 712 may be mounted to a sidewall of edifice 400. In some implementations edifice recess 710 may be located on a rear wall or a top or roof of edifice 400. In these implementations panel 712 is mounted to whatever wall of edifice 400 the recess 710 is positioned. The panel 712 may operate as a hatch and be pivotably mounted to the sidewall by one edge. The panel 712 may additionally have a latch 714 or comparable securing means to secure the panel to the sidewall. In some implementations the panel 712 may comprise a removable panel that completely detaches from the sidewall of the edifice 400 in order to expose the edifice recess 710 and the arm and dispenser assembly therein. In some implementations the door and/or mount point of the door may comprise a spring or motorized components to facilitate opening of the panel 712 via the deployment mechanism 708 seen in FIG. 7.

FIG. 9 shows a schematic diagram of an implementation of a system 100 having two dispenser assemblies 200 mounted to independent arms 300 mounted to edifice 400 within an edifice recess 710. Each arm 300 may be independently rotatable around an axis defined by the mounting point on the edifice 400. The coolant provider and primary reservoirs shown in FIG. 7 may each be separately routed through each of the arms 300. In some implementations each arm may have a separate coolant provider and one or more primary reservoirs, such that some flavors may be accessible from one dispenser assembly 200 and some accessible from another. In some implementations a user may choose to maintain independent swing arms 300 at different temperatures depending on the user's needs. Depending on the implementation, a user may elect to have the same flavors or different flavors travel through each swing arm 300 present to each swing arm 300's respective dispenser assembly 200. As a non-limiting example, a user may have first flavoring delivered through a first swing arm and second flavoring delivered through a second swing arm. In other implementations a user may have a first and second flavoring available through both the first swing arm and the second swing arm. In yet other implementations one swing arm may be dedicated to its own non-flavoring fluid, such as water with which a user may receive a drink or wash their hands. In other implementations a user may have three or more swing arms and may deliver individual, unique, combination, or any other configuration or organization of fluids through each swing arm 300 to dispenser assembly 200.

In various implementations the plurality of dispensers may be configured differently to attach to different portions and structures of the edifice. In an implementation a first dispenser may be configured to attach to a side surface of an edifice, while a second dispenser may be configured to fit over a window or door of the edifice. A second dispenser may comprise a linkage or may be statically attached to the edifice.

FIG. 10 shows a schematic diagram of a side view of a side view of edifice 400 having two swing arm dispenser assemblies that deploy vertically. In another implementation, a system 100 may have one or more swing arms 300 and dispenser assemblies 200 vertically mounted within an edifice recess 710. In such an implementation, the swing arms 300 may deploy by rotating away from the edifice 400 and down to a substantially horizontal “open” position. It will be appreciated that while reference is made to “horizontal” swing arms and “vertical” swing arms, a swing arm 300 may not move in a perfectly horizontal or vertical way relative to the edifice 400. In some implementations, a swing arm 300 may deploy at an angle relative to a sidewall of an edifice 400. The swing arms 300 may be connected to one overall bigger arm as illustrated in FIG. 9, or each swing arm 300 may be entirely separate as shown here. In some implementations, edifice 400 may feature one or more horizontally-deployed arms 300 (seen in, for example, FIG. 1) and one or more vertically-deployed arms 300 in the same implementation, as shown in FIG. 10B. While not shown in FIG. 10, vertically mounted swing arms 300 may be secured by deployment mechanisms 708 and/or locking mechanisms 706 as shown in FIG. 7 similar to horizontally mounted arms. Additionally, any number of swing arms, horizontal or vertical, may be operated by at least one deployment mechanism 708 or locking mechanism 706 depending on the implementation. In some implementations each arm present may be operated by its own deployment and/or locking mechanisms. In other implementations multiple arms may be operated by one deployment mechanism 708 or locking mechanism 706.

Additionally, the edifice recess 710 may have additional features within, such as a dispenser 1002. The dispenser 1002 is shown in FIG. 10A as a single unit, but those skilled in the art will appreciate one or more dispensers 1002 may be present depending on the implementation. Dispenser 1002 may additionally be located anywhere on edifice 400 and is not limited to placement within a recess 710, as shown in FIG. 10B. In some implementations dispenser 1002 may be detachable from edifice 400 and may be deployed as a standalone structure near edifice 400 or elsewhere. In some implementations, dispenser 1002 may be configured to dispense paper towels, napkins, wet wipes, or some other type of material to allow users to clean their hands, dry their hands, or otherwise receive a towel, napkin, wet wipe, or the like for any other reason. In some implementations, the dispenser 1002 may be configured to dispense plastic or some other material cutlery, such as a fork or spoon. In yet other implementations the dispenser 1002 may dispense additional cones or bowls to hold a frozen confection or similar confectionary item. In yet other implementations, one or more dispensers 1002 may be present and each may dispense one or more of some type of towel, cutlery, or additional confection containers.

While the dispenser 1002 shown in FIG. 10 is shown in an implementation of edifice 400 featuring vertically-deploying arms 300, it will be appreciated that one or more dispensers 1002 may be present in any implementation discussed herein. Additionally, while the dispenser 1002 is shown within an edifice recess 710 in FIG. 10, it will be appreciated that one or more dispensers 1002 may be mounted anywhere on edifice 400, or deployed stand-alone and remotely next to edifice 400 in another type of storage or container.

FIG. 11 shows a schematic diagram of a side view of edifice 400 having secondary topping dispensers. In addition to the swing arm assemblies, the edifice 400 may additionally have one or more topping dispensers 1102 mounted to the edifice 400. These topping dispensers 1102 may contain additional toppings separate from the syrups, such as marshmallow, cream, marshmallow cream, merengue, peanut butter, jelly, lemonade, chocolate syrup, carbonated water, soda, or other similar type of topping. These topping dispensers 1102 may or may not be cooled, and in implementations where they are cooled the topping dispensers 1102 may be connected to the chute or coolant system described in FIG. 7 or 12, or some other type of heating or cooling means depending on the implementation. The topping dispensers 1102 may terminate in a spigot, faucet, or similar means to allow users to control the amount of topping dispensed. In the present figure the topping dispensers 1102 are shown mounted to a sidewall of the edifice on the same sidewall as the edifice panel 712 and edifice recess 710, however, it will be appreciated that the secondary dispensers may be freely mounted anywhere on the edifice, or even deployed in stand-alone stands or similar next to and remote from the edifice 400. In other implementations one or more topping dispensers 1102 may be located within an edifice recess 710 together with swing arm dispenser assemblies or may be located within their own edifice recess depending on a user's needs.

FIG. 12 shows a schematic diagram of a side view of an edifice having a cooling chute. In some implementations the edifice 400 may, internally, feature a cooling chute 1202. During frozen confection production, it is often the case that leftover ice accumulates. This leftover ice may be found in an ice container where the ice simply does not get used, or found in ice shaving machines after shaving ice, or found elsewhere for whatever reason. In addition to or separately from cooling solutions like those described in FIG. 7, a user may use the residual, leftover ice with the cooling chute 1202. A user may additionally use separately from or in addition to “fresh” ice such as, for example, bagged ice or block ice purchased from a store, or in some instances even snow off the ground. The cooling chute may comprise a body and an opening within the body, and that opening may permit a user to introduce ice to an interior of the body. The tubing from primary reservoirs 704 may feed through the cooling chute and out to a swing arm 300 and come into contact with the ice fed through the chute 1202, thus chilling the tubing and the flavoring traveling therethrough. The ice in the cooling chute can thus be used to cool the flavoring within primary reservoirs 704 that travels through the tubing instead of or in addition to cooling solutions shown in FIG. 7.

It will be appreciated by those skilled in the art that, while several implementations are described and shown in the exemplary figures herein, one implementation may have any number of features shown. The figures shown herein are intended to be exemplary and non-limiting, and some figures show some features that other figures do not simply for clarity and readability. In other words, it is contemplated that one implementation of the present disclosure may feature each and every feature disclosed, or an implementation may feature a subset combination of the features shown without departing from the scope of the present disclosure.

In various implementations, a stand for holding or otherwise housing reservoirs and tubes, hoses or lines may be located outside of the edifice. The stand may be a metal stand or made from another material and may be configured to fit inside the edifice for transport to a location.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

In the foregoing Detailed Description, various features of the disclosure are grouped together in a single implementation for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed implementation. Thus, the following claims are hereby incorporated into this Detailed Description by this reference, with each claim standing on its own as a separate implementation of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

### EXAMPLES

The following examples pertain to further embodiments.

Example 1 is a system. The system comprises a dispenser assembly comprising an upper portion and a lower portion, an arm, and an edifice. The dispenser assembly is configured to be mounted to the arm and the arm is pivotably or rotatably mounted to an edifice.

Example 2 is a system as in Example 1, wherein the upper portion comprises a plurality of channels formed within a sidewall of the upper portion. The lower portion comprises a plurality of buttons that extend radially, wherein the lower portion is configured to couple to the upper portion by inserting the buttons into the channels. The upper portion includes a ridge, and each button includes a ridge that aligns with the ridge of the upper portion to form clamping surfaces that occlude a tubing that passes between the upper portion and the button.

Example 3 is a system as in any of Examples 1-2, wherein each button includes a push tab at an end of the button, the push tab extending beyond the channel when the lower portion is coupled to the upper portion.

Example 4 is a system as in any of Examples 1-3, wherein the tubing comprises a plurality of tubes, wherein each tube passes between one of the buttons and upper portion to thereby occlude the tube, and wherein the ridge of the upper portion is a circular ridge.

Example 5 is a system as in any of Examples 1-4, wherein each button includes a first opening and a second opening positioned outwardly from the first opening.

Example 6 is a system as in any of Examples 1-5, wherein the end of the button is angled upwardly to position the push tab above the first opening and the second opening.

Example 7 is a system as in any of Examples 1-6, wherein each of the lower portion and the upper portion includes a central opening through which the tubing passes.

Example 8 is a system as in any of Examples 1-7, wherein the upper portion is positioned above the lower portion, and wherein after the tubing passes through the central opening, each tube in the tubing passes through the first opening and then through the second opening of a corresponding button.

Example 9 is a system as in any of Examples 1-8, wherein the channels are configured to allow the push tab to be pressed downwardly to cause the corresponding tube to no longer be occluded between the ridge and the circular ridge.

Example 10 is a system as in any of Examples 1-9, wherein the upper portion includes a central opening for enabling the tubing to pass through the upper portion and a plurality of holes disposed within the central opening.

Example 11 is a system as in any of Examples 1-10, wherein the edifice further comprises a recess disposed within a sidewall of the edifice.

Example 12 is a system as in any of Examples 1-11, wherein the arm is disposed within the recess, and the arm is pivotally mounted to the edifice such that the dispenser assembly can change position between a deployed position and a stored position.

Example 13 is a system as in any of Examples 1-12, wherein the arm is fully within the recess in the stored position, and wherein the arm is protruding from the recess in the deployed position.

Example 14 is a system as in any of Examples 1-13, wherein the arm comprises a locking mechanism such that the arm can be locked in a stored position, a deployed position, or a partially deployed position.

Example 15 is a system as in any of Examples 1-14, wherein the system further comprises a panel, wherein the panel is a hatch pivotally attached to a sidewall of the edifice and the hatch is flush with the sidewall.

Example 16 is a system as in any of Examples 1-15, wherein the system further comprises a hatch door, and wherein the panel is a removable panel.

Example 17 is a system as in any of Examples 1-16, wherein the system further comprises one or more deployment mechanisms for operating the hatch door, for operating the arm, or for operating both the hatch door and the arm.

Example 18 is a system as in any of Examples 1-17, wherein the deployment mechanism comprises a lever or a button.

Example 19 is a system as in any of Examples 1-18, wherein the tubing extends from the edifice through the arm to the dispenser assembly.

Example 20 is a system as in any of Examples 1-19, wherein the edifice comprises a plurality of liquid dispensers and a coolant dispenser.

Example 21 is a system as in any of Examples 1-20, wherein the arm comprises a hollow interior and the hollow interior facilitates transfer of the coolant and one or more liquids from the liquid dispensers via the tubing through the arm to the dispenser assembly.

Example 22 is a system as in any of Examples 1-21, wherein the coolant dispenser contains a coolant, and wherein the coolant is a liquid coolant or a gaseous coolant.

Example 23 is a system as in any of Examples 1-22, wherein the arm comprises an insulating material.

Example 24 is a system as in any of Examples 1-23, wherein the system further comprises a second arm and a second dispenser assembly, wherein the second dispenser assembly is mounted to the second arm and the second arm is mounted to the edifice, and both the arm and the second arm may move independently of one another.

Example 25 is a system comprising an arm configured to be mounted to an edifice, wherein the arm is configured to move between an open position and a closed position, a dispenser assembly mounted to the arm, one or more tubes configured to span a length of the arm and terminate at the dispenser assembly, wherein the one or more tubes are configured to transport fluid along the length of the arm to the dispenser assembly.

Example 26 is a system as in Example 25, further comprising one or more reservoirs mounted to the edifice, each comprising a liquid, wherein the one or more reservoirs are in fluid communication with at least one of the one or more tubes; and a chute comprising an opening defined by a sidewall of the chute mounted to the edifice, wherein the chute is positioned relative to the one or more reservoirs and the arm such that the one or more tubes in fluid communication with the one or more reservoirs are fed through the opening of chute and to the arm.

Example 27 is a system as in Examples 25 or 26, wherein the dispenser assembly comprises an upper portion comprising a plurality of channels formed within a sidewall of the upper portion; and a lower portion comprising a plurality of prongs that extend radially from the lower portion; wherein the lower portion is configured to couple to the upper portion by inserting an end of each of the plurality of prongs into a corresponding channel of the plurality of channels of the upper portion; wherein the upper portion includes a plurality of upper ridges and each prong of the plurality of prongs of the lower portion includes a lower ridge that aligns with at least one of the upper ridges of the upper portion to form one or more clamping surfaces that occlude a tube that passes between the upper portion and the lower portion.

Example 28 is a system as in any of Examples 25-27, wherein each of the plurality of prongs of the lower portion comprises a push tab configured to be pressed such that pressing the push tab removes the occlusion of the tube that passes between the upper portion and the lower portion.

Example 29 is a system as in any of Examples 25-28, wherein the arm comprises a mount configured to join the arm to the edifice such that the arm is mounted to the edifice and retains a degree of movement about an axis defined by the mount.

Example 30 is a system as in any of Examples 25-29, wherein the arm further comprises a secondary dispenser in fluid communication with the arm, and wherein the arm is in fluid communication with the chute.

Example 31 is a system as in any of Examples 25-30, wherein the arm further comprises a secondary dispenser in fluid communication with at least one of the one or more tubes and in fluid communication with a secondary reservoir within the edifice.

Example 32 is a system as in any of Examples 25-31, wherein the arm comprises a plurality of arms, wherein each arm comprises a mount whereby each of the plurality of arms is mounted to the edifice, and wherein each arm is mounted to the edifice such that each arm maintains individual freedom of movement.

Example 33 is a system as in any of Examples 25-32, wherein the edifice comprises a recess, and wherein the closed position of the arm is a storage position whereby the arm is moved inside the recess of the edifice and flush with a sidewall of the edifice.

Example 34 is a system as in any of Examples 25-33, wherein the opening position comprises an operation position whereby the arm is moved out of the recess of the edifice such that the dispenser assembly of the arm is not within the recess of the edifice.

Example 35 is a system as in any of Examples 25-34, wherein the edifice comprises a recess door configured to completely cover the recess of the edifice, wherein the recess door is pivotally mounted to the edifice or removably attached to the edifice.

Example 36 is a system as in any of Examples 25-35, further comprising a tableware dispenser, wherein the tableware dispenser is configured to dispense one or more items of tableware.

Example 37 is a system as in any of Examples 25-36, further comprising one or more topping dispensers that are not in fluid communication with the one or more tubes, and configured to dispense one or more of a liquid, solid, or semi-solid topping.

Example 38 is a system as in any of Examples 25-37, further comprising a deployment mechanism, wherein the operating the deployment mechanism causes the arm to move between the open position and the closed position.

Example 39 is a system as in any of Examples 25-38, further comprising a locking mechanism, wherein engaging the locking mechanism prevents the arm from moving between the open position and the closed position, and wherein disengaging the locking mechanism permits the arm to move between the open position and the closed position.

Example 40 is a system as in any of Examples 25-39, wherein the chute is sufficiently large to receive a quantity of ice, such that the ice comes into contact with the one or more tubes and chills the liquid of the one or more fluid reservoirs.

Example 41 is a system as in any of Examples 25-41, further comprising one or more dispensing means configured to control flow of a liquid affixed to a terminal end of one or more of the one or more tubes, and wherein the dispensing means comprises one or more of a nozzle, spout, or faucet.

Example 42 is a system for servicing frozen confections comprising a mobile edifice; an arm configured to be mounted to the mobile edifice, wherein the arm is configured to move between an open position and a closed position; a dispenser assembly mounted to the arm; one or more tubes configured to span a length of the arm and terminate at the dispenser assembly, wherein the one or more tubes are configured to transport fluid along the length of the arm to the dispenser assembly.

Example 43 is a system as in Example 42, further comprising one or more reservoirs mounted to a sidewall of the mobile edifice, each comprising a liquid, wherein the one or more reservoirs are in fluid communication with at least one of the one or more tubes; and a chute comprising an opening defined by a sidewall of the chute mounted to the mobile edifice, wherein the chute is positioned relative to the one or more reservoirs and the arm such that the one or more tubes in fluid communication with the one or more reservoirs are fed through the opening of chute and to the arm.

Example 44 is a system as in Examples 42 or 43, wherein the arm comprises a plurality of arms, wherein each arm comprises a mount whereby each of the plurality of arms is mounted to a sidewall of the mobile edifice, and wherein each arm is mounted to the edifice such that each arm maintains individual freedom of movement.

Example 45 is a system as in any of Examples 42-44, wherein the arm further comprises a secondary dispenser in fluid communication with the arm, wherein the arm is in fluid communication with the chute.

Example 46 is a system as in any of Examples 42-45, wherein the arm further comprises a secondary dispenser in fluid communication with at least one of the one or more tubes and in fluid communication with a secondary reservoir within the mobile edifice.

Example 47 is a system as in any of Examples 42-46, further comprising one or more tertiary dispensers mounted externally on a sidewall of the mobile edifice and not in fluid communication with the one or more tubes, wherein the one or more tertiary dispensers are configured to dispense one or more of tableware or a solid, liquid, or semi-solid topping.

Example 48 is a system as in any of Examples 42-47, wherein the dispenser assembly comprises an upper portion comprising a plurality of channels formed within a sidewall of the upper portion; and a lower portion comprising a plurality of prongs that extend radially from the lower portion; wherein the lower portion is configured to couple to the upper portion by inserting an end of each of the plurality of prongs into a corresponding channel of the plurality of channels of the upper portion; wherein the upper portion includes a plurality of upper ridges and each prong of the plurality of prongs of the lower portion includes a lower ridge that aligns with at least one of the upper ridges of the upper portion to form one or more clamping surfaces that occlude a tube that passes between the upper portion and the lower portion; wherein each of the plurality of prongs of the lower portion comprises a push tab configured to be pressed such that pressing the push tab removes the occlusion of the tube that passes between the upper portion and the lower portion.

Example 49 is a system as in any of Examples 42-48, further comprising one or more dispensing means configured to control flow of a liquid affixed to a terminal end of one or more of the one or more tubes.

What is claimed is:

1. A system comprising:
an arm configured to be mounted to an edifice, wherein the arm is configured to move between an open position and a closed position;
a dispenser assembly mounted to the arm;
one or more tubes configured to span a length of the arm and terminate at the dispenser assembly, wherein the one or more tubes are configured to transport fluid along the length of the arm to the dispenser assembly.

2. The system of claim 1, further comprising:
one or more reservoirs mounted to the edifice, each comprising a liquid, wherein the one or more reservoirs are in fluid communication with at least one of the one or more tubes; and
a chute comprising an opening defined by a sidewall of the chute mounted to the edifice, wherein the chute is positioned relative to the one or more reservoirs and the arm such that the one or more tubes in fluid communication with the one or more reservoirs are fed through the opening of chute and to the arm.

3. The system of claim 1, wherein the dispenser assembly comprises:
an upper portion comprising a plurality of channels formed within a sidewall of the upper portion; and
a lower portion comprising a plurality of prongs that extend radially from the lower portion;
wherein the lower portion is configured to couple to the upper portion by inserting an end of each of the plurality of prongs into a corresponding channel of the plurality of channels of the upper portion;
wherein the upper portion includes a plurality of upper ridges and each prong of the plurality of prongs of the lower portion includes a lower ridge that aligns with at least one of the upper ridges of the upper portion to form one or more clamping surfaces that occlude a tube that passes between the upper portion and the lower portion.

4. The system of claim 3, wherein each of the plurality of prongs of the lower portion comprises a push tab configured to be pressed such that pressing the push tab removes the occlusion of the tube that passes between the upper portion and the lower portion.

5. The system of claim 1, wherein the arm comprises a mount configured to join the arm to the edifice such that the arm is mounted to the edifice and retains a degree of movement about an axis defined by the mount.

6. The system of claim 2, wherein the arm further comprises a secondary dispenser in fluid communication with the arm, and wherein the arm is in fluid communication with the chute.

7. The system of claim 2, wherein the arm further comprises a secondary dispenser in fluid communication with at least one of the one or more tubes and in fluid communication with a secondary reservoir within the edifice.

8. The system of claim 1, wherein the arm comprises a plurality of arms, wherein each arm comprises a mount whereby each of the plurality of arms is mounted to the edifice, and wherein each arm is mounted to the edifice such that each arm maintains individual freedom of movement.

9. The system of claim 1, wherein the system further comprises the edifice, and wherein the edifice comprises a recess, and wherein the closed position of the arm is a storage position whereby the arm is moved inside the recess of the edifice and flush with a sidewall of the edifice.

10. The system of claim 9, wherein the opening position comprises an operation position whereby the arm is moved out of the recess of the edifice such that the dispenser assembly of the arm is not within the recess of the edifice.

11. The system of claim 9, wherein the edifice comprises a recess door configured to completely cover the recess of the edifice, wherein the recess door is pivotally mounted to the edifice or removably attached to the edifice.

12. The system of claim 1, further comprising the edifice, wherein a tableware dispenser is mounted externally to a sidewall of the edifice, and wherein the tableware dispenser is configured to dispense one or more items of tableware.

13. The system of claim 1, further comprising one or more topping dispensers that are not in fluid communication with the one or more tubes, and configured to dispense one or more of a liquid, solid, or semi-solid topping.

14. The system of claim 1, further comprising a deployment mechanism, wherein the operating the deployment mechanism causes the arm to move between the open position and the closed position.

15. The system of claim 1, further comprising a locking mechanism, wherein engaging the locking mechanism prevents the arm from moving between the open position and the closed position, and wherein disengaging the locking mechanism permits the arm to move between the open position and the closed position.

16. The system of claim 2, wherein the chute is sufficiently large to receive a quantity of ice, such that the ice comes into contact with the one or more tubes and chills the liquid of the one or more fluid reservoirs.

17. The system of claim 2, further comprising one or more dispensing means configured to control flow of a liquid affixed to a terminal end of one or more of the one or more tubes, and
wherein the dispensing means comprises one or more of a nozzle, spout, or faucet.

18. A system for servicing frozen confections comprising:
a mobile edifice;
an arm configured to be mounted to the mobile edifice, wherein the arm is configured to move between an open position and a closed position;
a dispenser assembly mounted to the arm;
one or more tubes configured to span a length of the arm and terminate at the dispenser assembly, wherein the one or more tubes are configured to transport fluid along the length of the arm to the dispenser assembly.

19. The system of claim 18, further comprising:
one or more reservoirs mounted to a sidewall of the mobile edifice, each comprising a liquid, wherein the one or more reservoirs are in fluid communication with at least one of the one or more tubes; and
a chute comprising an opening defined by a sidewall of the chute mounted to the mobile edifice, wherein the chute is positioned relative to the one or more reservoirs and the arm such that the one or more tubes in fluid communication with the one or more reservoirs are fed through the opening of chute and to the arm.

20. The system of claim 18, wherein the arm comprises a plurality of arms, wherein each arm comprises a mount whereby each of the plurality of arms is mounted to a sidewall of the mobile edifice, and wherein each arm is mounted to the edifice such that each arm maintains individual freedom of movement.

21. The system of claim 18, wherein the arm further comprises a secondary dispenser in fluid communication with the arm, wherein the arm is in fluid communication with the chute.

22. The system of claim 18, wherein the arm further comprises a secondary dispenser in fluid communication with at least one of the one or more tubes and in fluid communication with a secondary reservoir within the mobile edifice.

23. The system of claim 18, further comprising one or more tertiary dispensers mounted externally on a sidewall of the mobile edifice and not in fluid communication with the one or more tubes, wherein the one or more tertiary dispensers are configured to dispense one or more of tableware or a solid, liquid, or semi-solid topping.

24. The system of claim 18, wherein the dispenser assembly comprises an upper portion comprising a plurality of channels formed within a sidewall of the upper portion; and a lower portion comprising a plurality of prongs that extend radially from the lower portion;
wherein the lower portion is configured to couple to the upper portion by inserting an end of each of the plurality of prongs into a corresponding channel of the plurality of channels of the upper portion;
wherein the upper portion includes a plurality of upper ridges and each prong of the plurality of prongs of the lower portion includes a lower ridge that aligns with at least one of the upper ridges of the upper portion to form one or more clamping surfaces that occlude a tube that passes between the upper portion and the lower portion;
wherein each of the plurality of prongs of the lower portion comprises a push tab configured to be pressed such that pressing the push tab removes the occlusion of the tube that passes between the upper portion and the lower portion.

25. The system of claim 18, further comprising one or more dispensing means configured to control flow of a liquid affixed to a terminal end of one or more of the one or more tubes.
